(19) United States
(12) Patent Application Publication
(10) Pub. No.: US 2018/0158113 A1
(43) Pub. Date: Jun. 7, 2018

(54) RICH CONTENT APPRAISAL REPORT GENERATOR

(71) Applicant: Value Connect Inc., Guelph (CA)

(72) Inventors: Christopher John Bisson, Guelph (CA); Mark Timothy George, Kitchener (CA); Devin Gauthier, Guelph (CA); Mark Norman Richard Monteiro, Sarnia (CA)

(21) Appl. No.: 15/370,374

(22) Filed: Dec. 6, 2016

(51) Int. Cl. G06Q 30/02; G06Q 50/16

(52) U.S. Cl. CPC G06Q 30/0278; G06Q 50/16

(57) ABSTRACT

The present invention is a system for generating property appraisal reports providing an appraisal of a property. The system includes a portable computing device running software that generates the property appraisal report according to an appraisal report specification. The software causes the computer processor to obtain required information and generate the appraisal report based on an appraisal report specification specifying items to be included in the report, including an estimated value of the property, a video of the property, and information about other properties comparable to the subject property. The appraisal report specification also specifies locations in the report to place the specified item. The software then generates the appraisal report for the subject property according to the appraisal report specification including each specified item in the specified location in the property appraisal report.

### FIELD OF THE INVENTION

The present invention relates generally to systems for generating property appraisal reports, and more particularly to systems for generating property appraisal reports incorporating rich content.

### BACKGROUND OF THE INVENTION

Mortgage Lenders often have difficulty obtaining the “whole picture” about a property because appraisers tend to be unbalanced in their approaches. They are often very optimistic or negative. For example, a property may be perfectly acceptable to a lender, however it may have a few basic deficiencies such as a small hole in a wall, some dated paint, or a step that needs to be replaced. A conservative appraiser may highlight all the negative issues with the property and will not spend an equal amount of time showcasing the positive aspects of it. This causes lenders to decline loans that would otherwise be approved, costing them money and losing them profits.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The invention provides a system for generating property appraisal reports. Each property appraisal report provides an appraisal by an appraiser of a subject property, which is a real property. The system includes a portable computing device, such as a smartphone, and software that runs on the portable computing device configured to generate the property appraisal report for the subject property according to an appraisal report specification. The portable computing device includes a computer processor that is programmable by software, a display screen, an electronic network interface for receiving information over an electronic network, such as the internet, and a camera controllable by the computer processor configured to enable to appraiser to cause the camera to capture digital photographs and videos.

The software causes the computer processor to obtain required information and generate the property appraisal report for the subject property. The software first retrieves an appraisal report specification specifying the format of the property appraisal report and multiple items to be included in the property appraisal report. The items include information identifying the subject property, an estimated value of the subject property, a video of a portion of the subject property, and information about other properties designated by the appraiser to be comparable to the subject property. The appraisal report specification also specifies, for each specified item, a location in the property appraisal report at which the specified item is to be placed.

The software receives the information identifying the subject property. The software receives, from the appraiser, the estimated value of the subject property. The software receives, from the camera the video of a portion of the subject property. The software also receives, via the network, the information about one or more other properties designated by the appraiser to be comparable to the subject property. The software then generates the property appraisal report for the subject property according to the appraisal report specification including each specified item in the specified location in the property appraisal report.

The network may be the internet, and the software may provide an interface for the appraiser to search for information over the internet regarding other properties designated by the appraiser to be comparable to the subject property, and to specify that particular information regarding such other properties be included in the property appraisal report.

The network may be the internet, and at least some of the information about other properties designated by the appraiser to be comparable to the subject property may be obtained by the appraiser using an internet browser running on the portable computing device. The computer processor may receive the information about other properties directly from the internet browser.

The information identifying the subject property may include the location of the property. The items specified in the appraisal report specification may further include an aerial image including the subject property, and the software may be further configured to cause the computer processor to automatically obtain the aerial image via the network based on the location of the property.

The property appraisal report may be an electronic report that is viewable on a display screen, and the video may be located at the specified location in the property appraisal report by including a link in the property appraisal report so that, when a user viewing the property appraisal report on a particular display screen selects the link, the video is played on the particular display screen.

The subject property may include a house. The video may be specified to be a video of a portion or all of the inside of the house, and the software may cause the portable computing device to prompt the appraiser to obtain the video using the camera inside the house. The items specified in the appraisal report specification may further include a second video of the outside of the house. The items specified in the appraisal report specification may also include a digital photograph of each room in the house, and the appraiser may use the camera to capture the digital photograph of each room.

The portable computing device may also include a global positioning system (GPS) receiver, the information identifying the subject property may include the geographic location of the subject property, and the computer processor may then receive the geographic location of the subject property from the GPS receiver when the appraiser is at the subject property. The property appraisal report specification may specify locations in the property appraisal report in which to place digital photographs of the subject property, and the software may be further configured to cause the computer processor to receive from the camera the digital photographs and include the digital photographs in the specified locations in the property appraisal report along with, for one or more of the photographs, location information obtained from the GPS receiver at the time the photograph was captured.

The software may be further configured to cause the computer processor to display to the appraiser a menu of the specified items to be included in the property appraisal report, where the appraiser can select one of the specified items and the computer processor then prompts the appraiser to obtain the specified item. The appraiser may select the video of a portion of the subject property, and the computer processor may then prompt the appraiser to obtain the video by putting the camera into video recording mode and displaying video obtained by the camera on the display screen of the portable computing device.

The items specified in the appraisal report specification may further include a digital photograph of the subject property, and the software may be further configured to permit the appraiser to capture the digital photograph using the camera and to annotate the digital photograph.

Immediately after the computer processor receives one of the specified items, the software may be configured to cause the computer processor to display a portion of the property appraisal report that includes the specified location of the specified item so that the specified item or a link to the specified item is displayed to the appraiser and the appraiser can add and edit text associated with the specified item in the property appraisal report.

The portable computing device may be a smartphone.

The locations in the property appraisal report at which the specified items are to be placed may be relative locations indicating the location of each specified item relative to the other specified items.

For each of the plurality of items specified in the appraisal report specification, the computer processor may automatically insert a title comprising text in the property appraisal report proximate to the specified item.

The items specified in the appraisal report specification may further include an aerial map view and the software may be further configured to cause the computer processor to automatically obtain the aerial map view via the network based on the location of the subject property.

### BRIEF DESCRIPTION OF THE DRAWINGS

FIG. 1 is a schematic diagram showing a portable computing device used by an appraiser to create an appraisal report for a subject property.

FIG. 2 is a simple example of a page of a generated appraisal report showing front and rear views of a house on the subject property.

FIG. 3 is a simple example of a page of a generated appraisal report showing links to video clips of the interior and exterior of the house on the subject property.

### DETAILED DESCRIPTION OF THE INVENTION

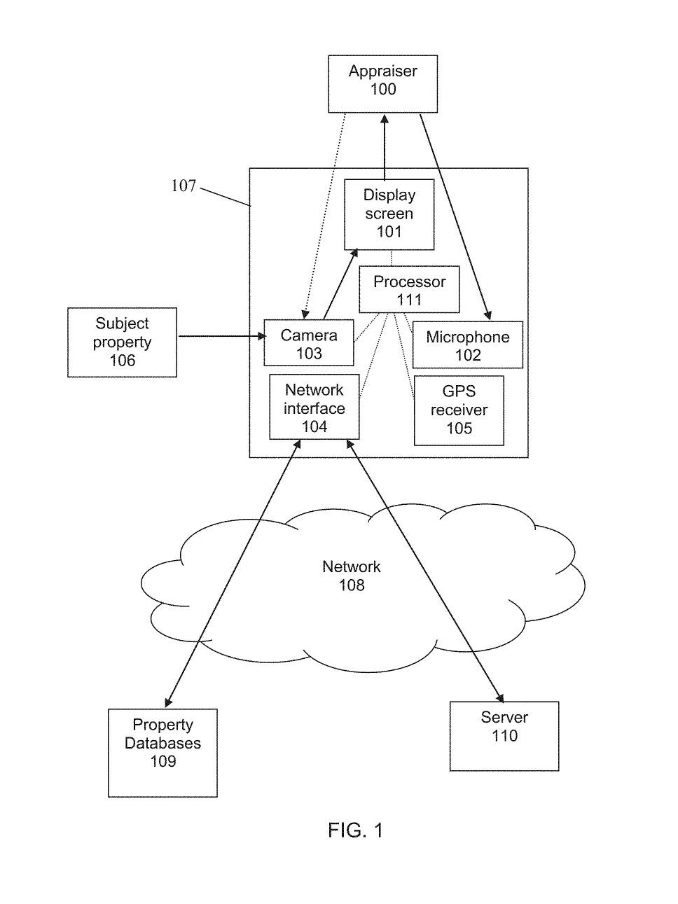

An embodiment of a system for generating property appraisal reports is shown schematically in FIG. 1. The system includes a portable computing device 107, such as a smartphone, running software that is configured to generate rich media property appraisal reports. The portable computing device 107 includes a programmable computer processor 111 running a software application (also referred to as an “app”), a display screen 101, a camera 103, a microphone 102, a network interface 104 and a global positioning system (GPS) receiver. The portable computing device 107 may also include a keyboard (not shown in FIG. 1), and/or the display screen 101 may be a touch screen for receiving input from the appraiser 100, such as text, menu selections and annotations/markings for rich media elements.

The system is employed by an appraiser 100 who carries the portable computing device 107 to a subject property 106 that the appraiser 100 has been tasked to appraise. Typically the subject property 106 has a house, or other structure or structures, situated on the property. Herein, for simplicity, it will generally be assumed that each property includes a single house with rooms therein.

The portable computing device 107 is typically a smartphone, but could be any suitable portable device, such as a tablet. The camera 103 is capable of taking digital photographs and video clips under the control of the appraiser 100 using the portable computing device 107. For example, in photograph mode the camera 103 may display on the display screen 101 the field of view currently observed by the camera lens and the appraiser 100 may then manipulate the portable computing device 107 to select a suitable position and configuration to obtain a digital photograph. For example, the appraiser 100 may take a photograph of the front of a house 201 situated on the subject property 106 from outside the house by pushing a button displayed over the currently displayed image on the display screen 101 such that when the appraiser 100 pushes the button, the current image is stored as a digital photograph which is automatically inserted into the pre-determined location in the report (either directly or via a link).

The system includes one or more appraisal report specifications each of which defines the format and contents of a property appraisal report. For example, the appraiser 100 may select an appraisal report specification for a subject property including a single family home.

The appraisal report specification specifies information that must or should be included in the report and may also specify optional information that can optionally be included. The information that must be included typically includes information identifying the subject property 106, an estimated value of the subject property 106 (i.e. an estimate of the current market value of the property in dollars), a video of a portion of the subject property 106, and information about one or more other properties designated by the appraiser 100 to be comparable to the subject property 106. The appraisal report specification also specifies where in the report each piece of information goes, and the software application obtains the information and directly inserts it into the report in the correct location as the report is being created by the portable computing device 107. Generally, for each specified item to be included in the report, the specification species a relative location to insert the item in the report, a heading for the section containing the item to be included in the report. In some cases, the specification may permit the appraiser to enter multiple instances of one item, such as comparable properties, which are generally then placed in sequence in the report, each with a suitable heading automatically inserted. The specification may also include specification of required information that needs to be entered by the appraiser in association with an item and a specification of the location in which it is to be entered. For example, in association with a front view photograph of the house, the specification may by default place a comments section after the photograph and prompt the appraiser to enter comments after providing the photograph.

Different appraisal report specifications may be provided for different classes of subject properties. For example an appraisal report specification for a condominium may be provided, and there may be separate appraisal report specifications for houses of different types, such as bungalows vs. multi-storey houses and single vs. multi-family houses, and based on the number of bedrooms, although generally this is not necessary as the number of rooms in the house need not be fixed by the appraisal report specification, which may facilitate the appraiser 100 adding information, including photographs, for an arbitrary number of rooms. The appraisal report specification may though specify that for each room certain information is required, such as a photograph, a name and a description.

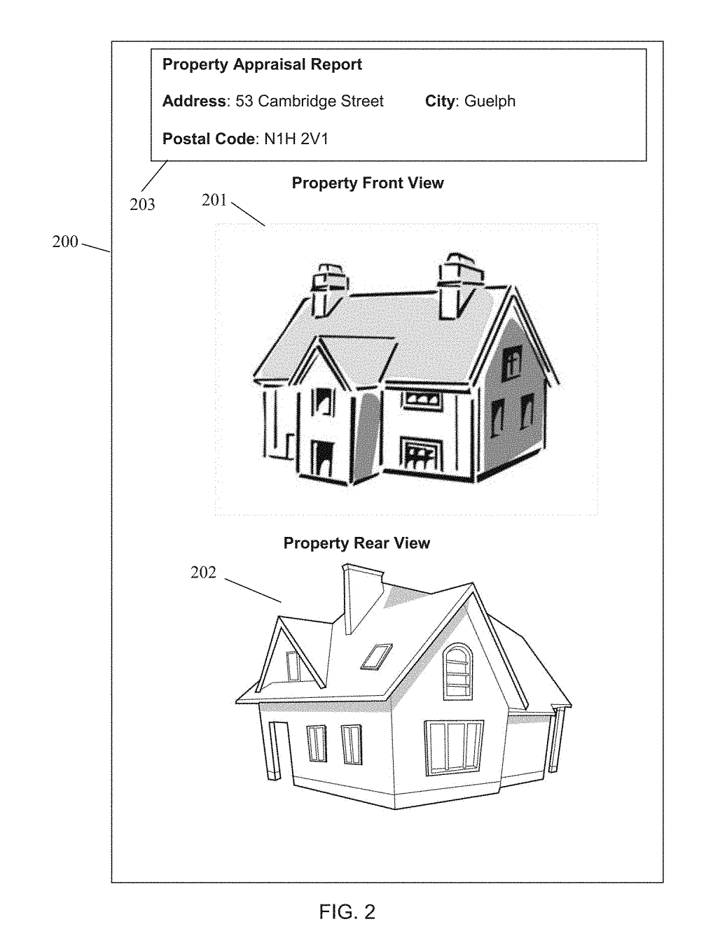

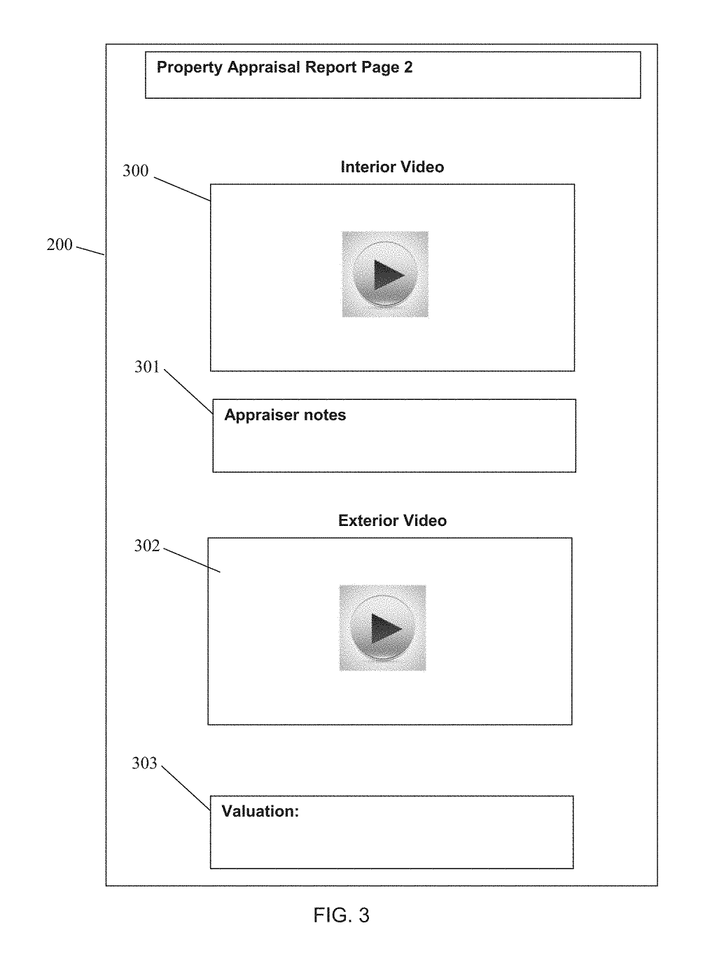

FIGS. 2 and 3 show very simple examples of two pages of a property appraisal report created by an embodiment of the system. The software application typically provides menus showing each required and optional element. The user (i.e. the appraiser 100) may go through the menu items one by one. For example, when creating a new report, after having selected a suitable appraisal report specification, the appraiser 100 may enter information identifying the subject property 203 either directly or by other means, such as selecting the property location from a map displayed on the display screen 101 of the portable computing device 107 so that the portable computing device 107 can automatically retrieve the location information.

The appraisal report specification may require that the appraiser 100 obtain front and rear digital photographs of the house on the subject property 106. For example, when arriving at the property, the appraiser may select “exterior front view photograph” from a menu presented by the software application running on the portable computing device 107. Then the portable computing device 107 may put the camera 103 into digital photograph mode in order to prompt the appraiser 100 to obtain a front view photograph 201 using the camera 103. Generally in this mode the display screen 101 displays what is in the field of view of the camera lens, and suitable controls are provided by the software application on the display screen 101, or via mechanical controls, so that the user can frame a suitable photograph and instruct the portable computing device 107 to record the photograph when the user is satisfied with what is displayed on the display screen 101. Framing the photograph may be facilitated by the user moving closer to or further away from the house while pointing the camera lens at the house, and/or by using digital or optical zooming if supported by the portable computing device 107. Once the user is satisfied with the image of the front of the house shown on the display screen 101, the user can then direct the portable computing device 107 to record the photograph, generally by pressing a button rendered on the display screen 101 or by pressing a physical button on the device 107. Based on the appraisal report specification, the software application knows where in the report the photograph of the front of the house 201 is to be placed and automatically inserts it into the report in that location with a heading such as “Property Front View” as shown in FIG. 2 above the corresponding photograph 201.

Such digital photographs may be included in the normal electronic view of the report, and in printed versions of the report, in relatively low resolution so that each photograph does not take up an inordinate amount of space in the report. However, when a user is viewing the report on a display screen the user may be given the option to click on such a low resolution photograph and thereby display a higher resolution version of the photograph, which is either embedded in the report or is linked to it.

The software application may also give the appraiser 100 the option to add related notes or annotations that will appear in the report in a specific location relative to the photograph that was recorded. For example, general comments about the appearance of the front of the house may be inserted directly under or beside the photograph of the front of the house 201 in the report (not shown in the figures). The software application may specifically prompt the appraiser 100 to provide such notes.

The software application may also permit the user to mark up a photograph, such as to draw a circle around a portion of the photograph that the user can then comment on in associated notes. For example, the appraiser 100 may mark up a photograph to circle or point to a portion of the roof of a house and then make a note about missing or damaged shingles.

The software application may require that the appraiser 100 enter at least a certain number of photographs, such as one front exterior photograph 201 and one rear exterior photograph 202 of a house, and at least one photograph of each room in the house (although the number of rooms may not be fixed). The software application may also give the appraiser 100 the option to add additional photographs where the appraiser 100 enters a description of the photograph and optionally enters related notes or annotations. A menu item may be provided for each room in the house so that as the appraiser 100 goes through the house, the appraiser 100 selects the appropriate menu item when entering each room (e.g. selecting “kitchen photograph” from the menu when entering the kitchen), and takes at least one digital photograph of the room, which the software application then inserts in the proper place in the report with a heading identifying the room. After recording the photograph of the kitchen, the software application may then prompt the appraiser 100 to provide notes about the kitchen and insert those notes into the report in a position near the photograph of the kitchen, such as directly following the photograph.

The software application may also allow the appraiser 100 to take multiple photographs within one room, where the appraiser 100 may provide separate notes to be associated with the photographs. In addition to notes, the software application may give the appraiser 100 the option to record verbal comments via the microphone 102 of the portable computing device 107. Such an audio recording may be directly linked in the report. For example, when the appraiser 100 is in the kitchen and has taken a photograph of the kitchen, the appraiser may choose to add an audio note which is then recorded by the portable computing device 107 and the software application places a link to the audio file (for example displays a play button) over or near to the photograph of the kitchen in the report. Then when one is viewing the report on a display screen, one may select the link, such as by pressing a play button on a touch screen or clicking on a button using a mouse, and the stored audio is played back. Such audio recordings may be permanently included in the report, or the appraiser 100 may decide to replace the audio links with suitable textual notes added to the report, for example when reviewing and finalizing the report using a personal computer in the appraiser's office.

Each appraisal report specification preferably requires at least two video clips of the property. Generally this will include a video clip of the exterior of the house on the property 302, preferably showing the entire exterior of the house, and at least one clip of the inside of the house 300, preferably showing the entire interior of the house. Additional clips, such as clips showing the surrounding neighborhood, yard(s), and/or other buildings on the property (interior and exterior) may also be included. A virtual reality walkthrough may also be included.

Appraiser notes 301 may also be entered by the appraiser 100 and included in association with each video clip. For example, when the appraiser 100 enters a house, the software application may prompt the appraiser 100 to take an interior video, or the appraiser 100 may select “interior video” from a menu displayed by the app, and then the software application places the camera 103 into video mode and presents start, stop and pause controls to the appraiser 100 for example. The appraiser 100 then takes the video, optionally providing audio comments as the video is being recorded. The appraiser 100 may, for example, walk around inside the house taking video inside each room of the house, pausing and re-starting the video recording as appropriate. Multiple clips may be separately recorded and stored, although it is preferred to have a single clip for the inside and a single clip for the outside of the house.

Once the appraiser 100 indicates to the software application that the video clip is complete, the software application then automatically inserts the video clip and/or a link to the video clip in a pre-determined location in the report. For example, as shown in FIG. 3, one page of the report may include an “Interior Video” heading followed by a link 300 to a video clip of the interior of the house, followed by an “Exterior Video” heading followed by a link 302 to a video clip of the exterior of the house. The appraiser 100 may also optionally enter notes 301 in association with each video clip that are placed in the report following or near the link to play the associated video clip. In general, rich media such as a video clip may be directly embedded in the report or only a link (e.g. using a uniform resource locator (URL)) may be included in the report where the link directs the software displaying the link to obtain and display the linked information, for example over the internet.

The appraiser 100 generally also must enter a valuation 303 of the property that is placed in the report. This may be done, at least tentatively, while the appraiser 100 is in the house, or it may be done or revised later. In addition to an estimated value of the subject property, the system may receive from the appraiser comparable property information, valuation adjustments, estimation of costs to rebuild or replace as if new, and other approaches to value used by appraiser professionals. Such information may also be included in the valuation section 303 of the appraisal report.

A key aspect of the system is that the software application gives the appraiser 100 the ability to link in information from various sources, such as property databases 109 that are accessed by the portable computing device 107 over a network 108 via a network interface 104 in the portable computing device 107. Such information includes sales history information for the property (amount paid and date of sale), as well as details on other properties that facilitate comparison to the subject property (such as number of bedrooms and bathrooms, floor area, type of house (e.g. number of floors), site size, days on market, location, building type, design/style, age/condition, livable floor area, parking and information regarding the neighbourhood the house is in (such as average house price in the area, average household income, proximity of schools, etc.). The appraiser may obtain similar information on the neighbourhood of the subject property via the software application and use this to help decide whether a particular property is comparable to the subject property. Such other properties may be referred to as “comparables” or “comps”, and the relevant factors are well known in the art (see, for example, https://en.wikipedia.org/wiki/Comparables).

The software application allows the appraiser to access detailed sales and property information, including site improvements, on various properties that can be imported into the report without leaving the software application. In such preferred embodiments the same software application that generates the report provides browser-like capabilities to permit the appraiser to search for and identify information regarding comparable properties/houses over the internet. The software application may allow the user to identify a particular portion of a web page to include in the report, such as by the appraiser drawing a rectangle around that portion when the web page is displayed on the display screen 101. Alternatively the software application may allow the user to invoke a separate browser and use that browser to identify relevant information to be entered into the report, which information is then preferably obtained by the software application directly from the browser. Alternatively, the appraiser could save such information in a file and instruct the software application to link/import that file.

The appraiser 100 may identify properties designated by the appraiser 100 to be comparable to the subject property 106 and include information about those properties to support the appraiser's appraisal. The information may be, for example, a link to an appraisal of a comparable property or a link to information regarding a recent sale of a comparable property. In some cases, the appraiser 100 may include a photograph of such a comparable property in the report.

The appraisal report specification may include menu items regarding comparable properties so that when the appraiser 100 inputs related information, the information is inserted into the report at a pre-determined location with a suitable heading automatically inserted indicating that the information is about a property deemed to be comparable to the subject property 106 by the appraiser. The software application of course allows the appraiser 100 to add notes to be inserted into the report in association with information about such a comparable property, for example the notes may elaborate on the similarities and differences between the subject property 106 and the comparable property.

The portable computing device 107 may have a GPS receiver 105, or other means, that allows the portable computing device 107 to determine its geographical location. The software application may then automatically determine the location of the house and subject property 106 and insert related information into the report when the appraiser 100 in near or in the house. The photographs taken by the camera 103 that are inserted in the appraisal report may be modified to include the GPS location information available when each photograph was taken, or the report may include the GPS coordinates in the report proximate to each photograph. This also provides an additional degree of assurance to a reader of the report that the photographs are all of the same property that is the subject of the appraisal.

The software application may also use the location information for example to determine when the appraiser is moving away from the house. For example, if the software application determines that the appraiser 100 has exited the house on the subject property 106 but has not recorded a required interior video clip of the house, the software application may prompt the appraiser 100 to do so, for example by displaying a notice on the display screen 101 and/or by playing sounds through an audio speaker in the portable computing device 107.

The appraisal report may be generated by the software application and be immediately available to review and edit via the portable computing device 107 in complete or partial form. Normally the draft report will be assembled on the portable computing device 107 and transmitted to a server 110. Preferably the information entered in the report is sent to the server 110 in real-time so that a complete backup of the incomplete report is available on the server 110 at all times as it is being created.

Typically then the appraiser 100 will further edit the report, for example using a desktop computer system that accesses the server 110. The appraiser 100 may preview and edit portions of the report, and may incorporate additional information into the report, such as information about additional comparable properties. The report itself can be generated in any suitable format that supports embedded media links and/or embedded media, such as Adobe's portable document format (PDF). The report generation may be done on the portable computing device 107 initially, but normally it will be regenerated via another computer system when the appraiser 100 makes the final edits to the report.

The software application may allow the appraiser 100 to automatically include map photographs/images including an aerial map view and satellite aerial image with the click of a button, for example, based on the address of the subject property 106.

When video is embedded in a report, the report will generally display on a screen, or show in a hard copy, a frame from the video, or other suitable cover photograph, overlaid with a play button or with a play control near the cover photograph. When being viewed on a display screen by suitable software, the user can then click on the displayed play button to watch the video clip and listen to any associated audio content recording by the appraiser 100. Generally, the video clip is embedded in the appraisal report, but in some cases it may be accessed from a separate location, such as an internet link or a link to a separate document on the user's computer or local computer network. Appropriate controls to pause, rewind and fast-forward the video may also be made available to the user. The video may be viewed in-place, where a rectangular space in the report that initially shows a frame of the video (such as the rectangular space 300 shown in FIG. 3), for example, is located. Such video is generally displayed at reduced resolution because of the limitation imposed by the size of the rectangular space allocated to the video clip in the report, but an option is provided in preferred embodiments to enlarge the video, for example to use the full display screen on which the report is being viewed, at the full resolution that the video was recorded or at least as high resolution as the display screen permits.

While it is generally preferred that the information to be included in a report is directly obtained and inserted in the report directly by the portable computing device 107 comprising (e.g. via the camera 103, network interface 104, keyboard or touch screen), the system also permits other media, such as separately recorded video clips and photographs to be inserted, either when the appraiser 100 is using the portable computing device 107 (e.g. by retrieving a photograph via the internet), or later on a separate computer the appraiser 100 uses to edit the report initially created on the portable computing device 107 that was uploaded to a server 110.

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

1. A system for generating electronic property appraisal reports, each property appraisal report providing an appraisal by an appraiser of a subject property, the subject property being a real property, the system comprising:
a portable computing device comprising:
a computer processor, the computer processor being programmable by software;
a display screen;
an electronic network interface for receiving information over an electronic network; and
a camera configured to capture digital photographs and videos; and
software that when executed by the computer processor causes the computer processor to:
retrieve an appraisal report specification specifying:
the format of the property appraisal report;
a plurality of items to be included in the property appraisal report including information identifying the subject property, an estimated value of the subject property, a video of a portion of the subject property, and information about one or more other properties designated by the appraiser to be comparable to the subject property; and
for each specified item, a location in the property appraisal report at which the specified item is to be placed;
receive the information identifying the subject property;
receive from the appraiser the estimated value of the subject property;
receive from the camera the video of a portion of the subject property;
receive via the network the information about other properties designated by the appraiser to be comparable to the subject property;
generate the property appraisal report for the subject property according to the appraisal report specification including each specified item in the specified location in the property appraisal report.

2. The system of claim 1, wherein the network is the internet, and the software provides an interface for the appraiser to search for information over the internet regarding the other properties designated by the appraiser to be comparable to the subject property, and to specify that the information regarding the other properties be included in the property appraisal report.

3. The system of claim 1, wherein the network is the internet, and at least some of the information about other properties designated by the appraiser to be comparable to the subject property is obtained by the appraiser using an internet browser running on the portable computing device.

4. The system of claim 3, wherein the computer processor receives the information about other properties directly from the internet browser.

5. The system of claim 1, wherein the portable computing device further comprises a global positioning system (OPS) receiver, the information identifying the subject property includes the geographic location of the subject property, and the computer processor receives the geographic location of the subject property from the GPS receiver when the appraiser is at the subject property.

6. The system of claim 5, wherein the property appraisal report specification specifies locations in the property appraisal report in which to place digital photographs of the subject property, and the software is further configured to cause the computer processor to receive from the camera the digital photographs and include the digital photographs in the specified locations in the property appraisal report along with, for one or more of the photographs, location information obtained from the GPS receiver at the time the photograph was captured.

7. The system of claim 1, wherein the information identifying the subject property includes the location of the property, the plurality of items specified in the appraisal report specification further includes an aerial image including the subject property, and the software is further configured to cause the computer processor to automatically obtain the aerial image via the network based on the location of the property.

8. The system of claim 1, wherein the video is located at the specified location in the property appraisal report by including a link in the property appraisal report wherein when a user viewing the property appraisal report selects the link the video is displayed to the user.

9. The system of claim 1, wherein the subject property comprises a house, the video is specified to be a video of the inside of the house, and the software causes the portable computing device to prompt the appraiser to obtain the video using the camera inside the house.

10. The system of claim 9, wherein the plurality of items specified in the appraisal report specification further includes a second video of the outside of the house.

11. The system of claim 9, wherein the house has a plurality of rooms, the plurality of items specified in the appraisal report specification further includes a digital photograph of each room in the house, and the appraiser uses the camera to capture the digital photograph of each room.

12. The system of claim 1, wherein the software is further configured to cause the computer processor to display to the appraiser a menu of the specified items to be included in the property appraisal report, wherein the appraiser can select one of the specified items and the computer processor then prompts the appraiser to obtain the specified item.

13. The system of claim 12, wherein when the appraiser selects the video of a portion of the subject property, the computer processor prompts the appraiser to obtain the video by putting the camera into video recording mode and displaying video obtained by the camera on the display screen of the portable computing device.

14. The system of claim 1, wherein the plurality of items specified in the appraisal report specification further includes a digital photograph of the subject property, and wherein the software is configured to permit the appraiser to capture the digital photograph using the camera and to annotate the digital photograph.

15. The system of claim 1, wherein immediately after the computer processor receives one of the specified items, the software causes the computer processor to display a portion of the property appraisal report that includes the specified location of the specified item so that the specified item or a link to the specified item is displayed to the appraiser and the appraiser can provide and edit text associated with the specified item in the property appraisal report that is automatically inserted in the property appraisal report proximate to the specified item by the computer processor.

16. The system of claim 1, wherein the portable computing device is a smartphone.

17. The system of claim 1, wherein the locations in the property appraisal report at which the specified items are to be placed are relative locations indicating the location of each specified item relative to the other specified items.

18. The system of claim 1, wherein for each of the plurality of items specified in the appraisal report specification, the computer processor automatically inserts a title comprising text in the property appraisal report proximate to the specified item.

19. The system of claim 1, wherein the plurality of items specified in the appraisal report specification further includes an aerial map view and the software is further configured to cause the computer processor to automatically obtain the aerial map view via the network based on the location of the subject property.

20. A method for making a system for generating an electronic property appraisal report providing an appraisal by an appraiser of a subject property, the subject property being a real property, using a portable computing device comprising a programmable computer processor, a display screen, an electronic network interface for receiving information over an electronic network, and a camera configured to capture digital photographs and videos, the method comprising:
providing software that when executed by the computer processor causes the computer processor to:
retrieve an appraisal report specification specifying:
the format of the property appraisal report;
a plurality of items to be included in the property appraisal report including information identifying the subject property, an estimated value of the subject property, a video of a portion of the subject property, and information about one or more other properties designated by the appraiser to be comparable to the subject property; and
for each specified item, a location in the property appraisal report at which the specified item is to be placed;
receive the information identifying the subject property;
receive from the appraiser the estimated value of the subject property;
receive from the camera the video of a portion of the subject property;
receive via the network the information about other properties designated by the appraiser to be comparable to the subject property; and
generate the property appraisal report for the subject property according to the appraisal report specification including each specified item in the specified location in the property appraisal report, and
installing the software on the portable computing device.
